(19) United States
(12) Patent Application Publication
(10) Pub. No.: US 2016/0243753 A1
(43) Pub. Date: Aug. 25, 2016

(54) PATTERN FORMING METHOD AND PATTERN FORMING APPARATUS

(71) Applicant: KABUSHIKI KAISHA TOSHIBA, Tokyo (JP)

(72) Inventors: Masayuki HATANO, Yokohama (JP); Yoshihisa KAWAMURA, Yokkaichi (JP)

(21) Appl. No.: 14/844,538

(22) Filed: Sep. 3, 2015

(30) Foreign Application Priority Data
Feb. 24, 2015 (JP) 2015-034018

(51) Int. Cl. B29C 59/02

(52) U.S. Cl. CPC B29C 59/026; B29L 2007/001

(57) ABSTRACT

In a pattern forming method of an embodiment, a template pattern formed on a front side of a template is brought into contact with resist placed on a substrate. Moreover, in the pattern forming method, rear pressure being an ambient pressure on a back side of the template is adjusted to a second pressure. Moreover, in the pattern forming method, the resist is filled in the template pattern under the second pressure to be cured.

### CROSS-REFERENCE TO RELATED APPLICATIONS

This application is based upon and claims the benefit of priority from Japanese Patent Application No. 2015-034018, filed on Feb. 24, 2015; the entire contents of which are incorporated herein by reference.

### FIELD

Embodiments described herein relate generally to a pattern forming method and a pattern forming apparatus.

### BACKGROUND

Attention is focused on an imprint method for transferring a pattern of a template to a substrate, as a technology for forming a fine pattern of a semiconductor device or the like with high productivity. In the imprint method, the template (original plate) on which an uneven pattern (template pattern) has been formed is brought into contact with resist applied on the substrate. Consequently, the resist is filled in the uneven pattern of the template. The filled resist is cured to transfer the template pattern to the resist on the substrate.

In the imprint method, stress is applied to the template when the template is impressed onto the resist. Hence, the template is distorted. Furthermore, the resist squeezes out from the uneven pattern-formation-purpose surface of the template. Especially, in the known imprint method, the template is pressed against the resist while pressure is applied to the back side of the template. Accordingly, a large amount of the resist squeezes out. It takes a long time to recover the distorted template and the squeezed-out resist. Accordingly, the productivity of the imprint method is not high.

### BRIEF DESCRIPTION OF THE DRAWINGS

FIG. 1 is a diagram illustrating the configuration of an imprint apparatus according to a first embodiment;

FIG. 2 is a diagram illustrating a processing procedure of an imprint step according to the first embodiment;

FIGS. 3A to 3C are diagrams illustrating pressure control in the imprint step according to the first embodiment;

FIG. 4 is a diagram illustrating a processing procedure of an imprint step according to a second embodiment;

FIGS. 5A to 5C are diagrams illustrating pressure control in the imprint step according to the second embodiment;

FIG. 6 is a diagram illustrating a processing procedure of an imprint step according to a third embodiment;

FIGS. 7A to 7C are diagrams illustrating pressure control in the imprint step according to the third embodiment;

FIG. 8 is a diagram illustrating a processing procedure of an imprint step according to a fourth embodiment;

FIGS. 9A to 9C are diagrams illustrating pressure control in the imprint step according to the fourth embodiment;

FIG. 10 is a diagram illustrating a processing procedure of an imprint step according to a fifth embodiment;

FIG. 11 is a diagram illustrating the state of squeezed-out resist, the state being observed in the imprint step according to the fifth embodiment;

FIG. 12 is a diagram illustrating a processing procedure of an imprint step according to a sixth embodiment;

FIG. 13 is a diagram illustrating the configuration of an imprint apparatus according to a seventh embodiment;

FIG. 14 is a diagram illustrating a processing procedure of an imprint step according to the seventh embodiment;

FIGS. 15A to 15D are diagrams illustrating pressure control and exhaust velocities in the imprint step according to the seventh embodiment;

FIG. 16 is a diagram illustrating the configuration of a spin coating mechanism according to an eighth embodiment;

FIG. 17 is a diagram illustrating a processing procedure of an imprint step according to the eighth embodiment; and

FIGS. 18A to 18C are diagrams illustrating pressure control in the imprint step according to the eighth embodiment.

### DETAILED DESCRIPTION

Exemplary embodiments of a pattern forming method and a pattern forming apparatus will be explained below in detail with reference to the accompanying drawings. The present invention is not limited to the following embodiments.

According to one embodiment, a pattern forming method is provided. In the pattern forming method, a template pattern formed on the front side of a template is brought into contact with resist placed on a substrate. Moreover, in the pattern forming method, rear pressure being ambient pressure on the back side of the template is adjusted to a second pressure. Moreover, in the pattern forming method, the resist is filled in the template pattern under the second pressure to be cured.

### First Embodiment

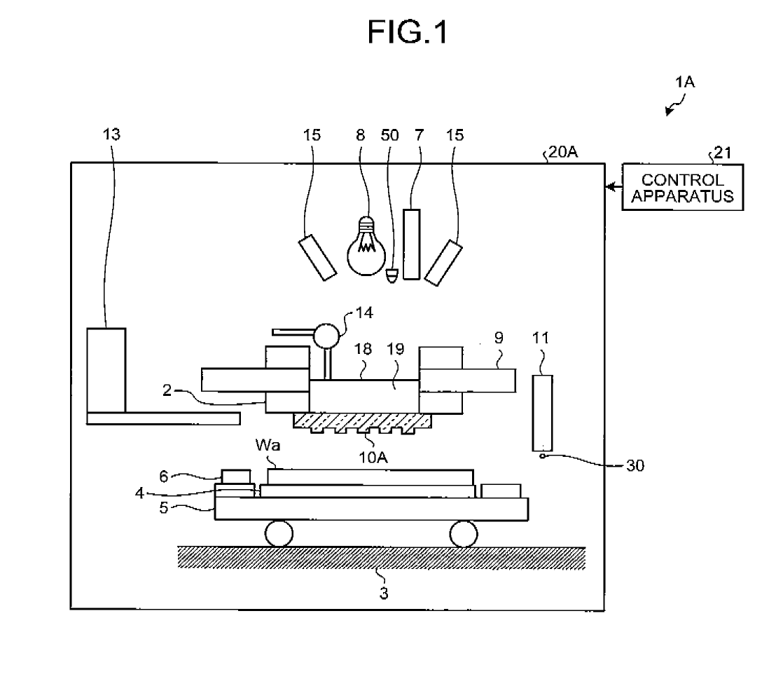

FIG. 1 is a diagram illustrating the configuration of an imprint apparatus according to a first embodiment. An imprint apparatus 1A is an apparatus that transfers a template pattern of a template 10A being a mold substrate to a to-be-transferred substrate such as a wafer Wa. The imprint apparatus 1A forms a pattern on the wafer Wa using an imprint method such as optical nanoimprint lithography.

The imprint apparatus 1A of the embodiment adjusts rear pressure (an atmosphere on the back side) of the template 10A to negative pressure when filling the resist 30 in a template pattern. Note that the term “fill” used in the embodiments may also mean “supply”, “infiltrate”, “permeate”, “flow”, or “impregnate”. The template 10A is a mold of a template. The template pattern is, for example, a circuit pattern to be transferred to the wafer Wa, and is formed on the front side of the template 10A. The template 10A is formed using a substantially flat plate-shaped silica glass substrate or the like.

The template 10A of the embodiment is a Rigid template that is not provided with a level difference (that is not cored out) on the back of the template pattern being an uneven pattern. Moreover, the imprint apparatus 1A is an apparatus that repeats the process of dropping the resist 30, the process of impressing the template 10A onto the resist 30, and the process of separating the template 10A from the resist 30, on an imprint shot by imprint shot basis.

The imprint apparatus 1A includes a processing mechanism 20A and a control apparatus 21. The processing mechanism 20A transfers the template pattern to the wafer Wa in accordance with an instruction of the control apparatus 21.

The processing mechanism 20A includes a template stage 2, a stage surface plate 3, a substrate chuck 4, a sample stage 5, a reference mark 6, an alignment sensor 7, a UV light source 8, a stage base 9, and a liquid drop apparatus 11. Moreover, the processing mechanism 20A includes a template carrying arm 13, a rear pressure adjustment mechanism (pressure adjustment unit) 14, a flatness measurement apparatus 15, a rear cover 18, and a CCD camera 50.

The stage surface plate 3 has a main surface in the horizontal direction. The sample stage 5 moves over the main surface. The wafer Wa is mounted on the sample stage 5. The sample stage 5 moves in a plane (horizontal plane) parallel to the wafer Wa mounted thereon. Moreover, the sample stage 5 moves the wafer Wa to below the liquid drop apparatus 11 when the resist 30 as a transfer material is dropped on the wafer Wa. Moreover, the sample stage 5 moves the wafer Wa to below the template 10A when the impress process is performed on the wafer Wa.

Moreover, the substrate chuck 4 is provided on the sample stage 5. The substrate chuck 4 fixes the wafer Wa at a predetermined position on the sample stage 5. Moreover, the reference mark 6 is provided on the sample stage 5. The reference mark 6 is a mark for detecting the position of the sample stage 5, and is used for positioning upon loading the wafer Wa onto the sample stage 5.

The template stage 2 is provided to a wafer Wa side being a bottom side of the stage base 9. The template stage 2 fixes the template 10A at a predetermined position by vacuum suction or the like from the back side (the surface on the side where the template pattern has not been formed) of the template 10A.

The stage base 9 supports the template 10A with the template stage 2 and presses the template pattern of the template 10A against the resist 30 on the wafer Wa. The stage base 9 moves in the perpendicular direction. Accordingly, the stage base 9 gives a press against the resist 30 on the template 10A and separates the template 10A from the resist 30 (mold separation).

Moreover, the alignment sensor 7 is provided above the stage base 9. The alignment sensor 7 is a sensor for detecting the position of the wafer Wa and detecting the position of the template 10A.

The liquid drop apparatus 11 is an apparatus that drops the resist 30 on the wafer Wa by the inkjet method. An inkjet head (not illustrated) of the liquid drop apparatus 11 includes a plurality of micropores that ejects droplets of the resist 30.

The template carrying arm 13 is an arm that carries the template 10A in the imprint apparatus 1A. The template carrying arm 13 carries the template 10A carried in from the outside of the imprint apparatus 1A, to below the template stage 2.

The UV light source (curing processing unit) 8 is a light source that applies UV light including light of a wavelength that can cure the resist 30 (for example, 300 to 380 nm). The UV light source 8 is provided above the stage base 9. The UV light source 8 applies UV light from above the template 10A while the template 10A is being pressed against the resist 30.

The rear cover 18 is a cover being a plate-shaped member provided on an upper side of the template stage 2. The rear cover 18 covers the upper side of the template stage 2 and the back side of the template 10A with the plate-shaped member. Between the rear cover 18 and the back side of the template 10A is a predetermined space 19. The pressure in the space 19 is adjusted by the rear pressure adjustment mechanism 14.

The rear pressure adjustment mechanism 14 is an apparatus that adjusts pressure on the back side (at the rear) of the template 10A. The rear pressure adjustment mechanism 14 adjusts rear pressure being ambient pressure on the back side of the template 10A. Specifically, the rear pressure adjustment mechanism 14 adjusts the pressure of the space 19 surrounded by the rear cover 18, the back of the template 10A, and the sides of the template stage 2. The rear pressure adjustment mechanism 14 has the functions of decompressing and compressing the space 19.

The rear pressure adjustment mechanism 14 adjusts the pressure of the space 19 to atmospheric pressure or positive pressure when the template 10A is pressed against the resist 30 on the wafer Wa. Moreover, the rear pressure adjustment mechanism 14 adjusts the pressure of the space 19 to negative pressure when the resist 30 is filled in the template pattern.

The flatness measurement apparatus 15 is an apparatus that measures the flatness of a template pattern surface. The flatness measurement apparatus 15 is provided above the template stage 2. The flatness measurement apparatus 15 applies light of a predetermined wavelength to the template pattern surface or the back side of the template 10A, and causes the applied light to be reflected on the back side of the template 10A. The flatness measurement apparatus 15 measures the flatness of the template pattern surface based on the interference degree of the reflected light from the template 10A.

The CCD camera 50 captures images of the resist 30 from above the template 10A or a template 10B described below. Specifically, the CCD camera 50 captures images of the back side of the template pattern and the resist 30 squeezed out from the template pattern. The CCD camera 50 transmits the captured images to the control apparatus 21.

The control apparatus 21 is connected to each component of the processing mechanism 20A and controls the components. The control apparatus 21 of the embodiment transmits, to the rear pressure adjustment mechanism 14, an instruction to adjust the pressure of the space 19 to negative pressure when filling the resist 30 in the template pattern.

Upon imprinting on the wafer Wa, the wafer Wa mounted on the sample stage 5 is moved to directly below the liquid drop apparatus 11. The resist 30 is dropped within a predetermined shot area of the wafer Wa.

After the resist 30 has been dropped on the wafer Wa, the wafer Wa on the sample stage 5 is moved to directly below the template 10A. The template 10A is then pressed against the resist 30 on the wafer Wa.

After the template 10A has been brought into contact with the resist 30 only for a predetermined time, UV light is applied to the resist 30 in this state. The resist 30 is then cured. Consequently, a transfer pattern corresponding to the template pattern is patterned on the resist 30 on the wafer Wa. The imprint process is subsequently performed for the next shot.

The imprint apparatus 1A may press the resist 30 against the template pattern, instead of pressing the template pattern against the resist 30. In this case, the sample stage 5 presses the resist 30 on the wafer Wa against the template pattern. In this manner, a contact processing unit that closes the distance between the template pattern and the wafer Wa on which the resist 30 has been placed to a predetermined distance is the sample stage 5 or the stage base 9. The imprint apparatus 1A closes the distance between the template pattern and the wafer Wa on which the resist 30 has been placed to the predetermined distance when pressing the template pattern against the resist 30.

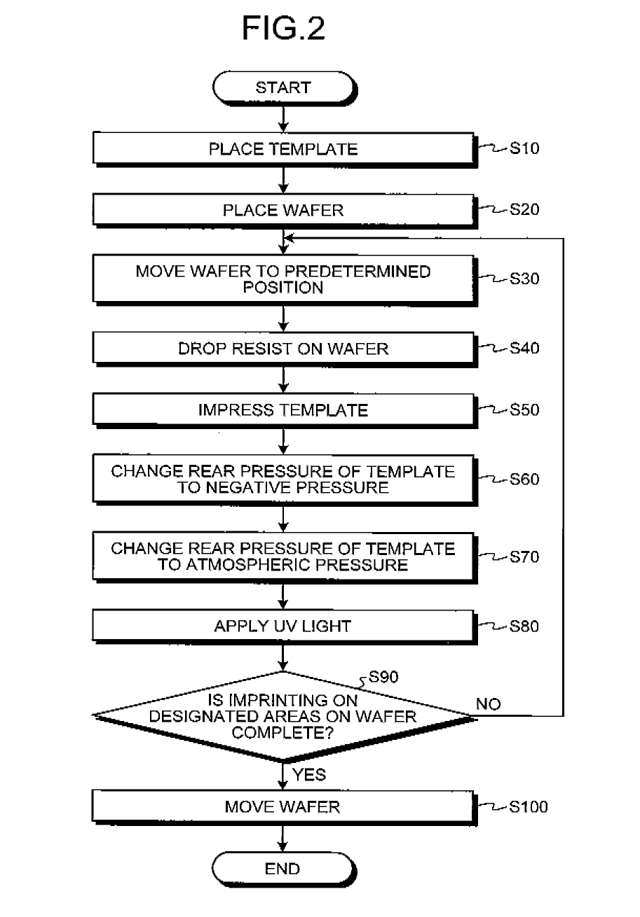

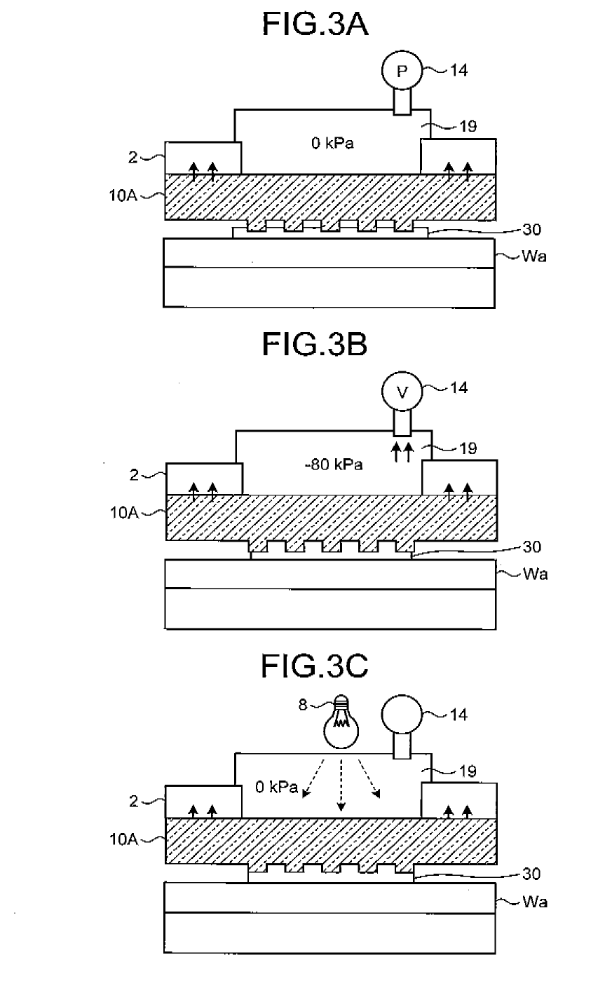

FIG. 2 is a diagram illustrating a processing procedure of an imprint step according to the first embodiment. Moreover, FIGS. 3A to 3C are diagrams illustrating pressure control in the imprint step according to the first embodiment. FIGS. 3A to 3C illustrate cross-sectional views of the wafer Wa, the template 10A, and the like in the imprint step.

In the imprint step according to the first embodiment, the template 10A is carried into the imprint apparatus 1A. The template 10A is then placed at a predetermined position in the processing mechanism 20A (Step S10). Specifically, the template 10A is fixed by the template stage 2. At this point in time, the template stage 2 suctions an area (outer peripheral area) being part of the back of the template 10A with an electrostatic chuck or vacuum chuck (for example, −70 kPa).

Moreover, the wafer Wa is carried into the imprint apparatus 1A. The wafer Wa is then placed at a predetermined position in the processing mechanism 20A (Step S20). Specifically, the wafer Wa is fixed by the substrate chuck 4.

The wafer Wa is subsequently moved by the sample stage 5 to a predetermined position (below the liquid drop apparatus 11) (Step S30). The liquid drop apparatus 11 then drops the resist 30 on the wafer Wa (Step S40). The resist 30 is resin such as light curable resin. Furthermore, the wafer Wa is moved by the sample stage 5 to a predetermined position (below the template 10A).

The distance between the template 10A and the wafer Wa is closed (reduced) to the predetermined distance when the template 10A is impressed onto the resist 30. Specifically, the stage base 9 impresses the template 10A supported by the template stage 2 onto the resist 30 (Step S50). At this point in time, the control apparatus 21 transmits, to the rear pressure adjustment mechanism 14, an instruction to adjust the rear pressure of the template 10A (the space 19) to atmospheric pressure (0 kPa). Consequently, the rear pressure adjustment mechanism 14 adjusts the space 19 to 0 kPa as illustrated in FIG. 3A. In this manner, the imprint apparatus 1A adjusts the back side of the template 10A to atmospheric pressure when pressing the template 10A against the resist 30.

When the template 10A is pressed against the resist 30, the template 10A distorts (warps) while the resist 30 squeezes out from the template pattern surface. In this state, the resist 30 starts being filled in the template pattern. In this manner, when the template 10A made by carving a silica substrate or the like is brought into contact with the resist 30, a capillary phenomenon allows the resist 30 to start flowing into the template pattern.

After the template 10A has been pressed against the resist 30, the control apparatus 21 transmits, to the rear pressure adjustment mechanism 14, an instruction to adjust the rear pressure of the template 10A to negative pressure (for example, −10 to −200 kPa). Consequently, the rear pressure adjustment mechanism 14 decompresses the space 19 (an area on the back of the template 10A, which is not chucked by the template stage 2). As a result, the space 19 is adjusted to a negative pressure, for example, −80 kPa, as illustrated in FIG. 3B (Step S60). In this manner, the imprint apparatus 1A adjusts the back side of the template 10A to negative pressure when filling the resist 30 in the template pattern.

When the back side of the template 10A has been adjusted to negative pressure, the distortion (deformation) of the template 10A is solved in a short time. Moreover, if the back side of the template 10A is adjusted to negative pressure, the resist 30 squeezed out from the template pattern surface is solved in a short time. As a result, the filling of the resist 30 in the template pattern is completed in a short time.

When the filling of the resist 30 is complete, the control apparatus 21 transmits, to the rear pressure adjustment mechanism 14, an instruction to adjust the rear pressure of the template 10A to atmospheric pressure. Consequently, the rear pressure adjustment mechanism 14 compresses the space 19. As a result, the space 19 is adjusted to atmospheric pressure (0 kPa) as illustrated in FIG. 3C (Step S70).

The UV light source B then applies UV light to the resist 30 through the template 10A (Step S80). Consequently, the resist 30 is cured. In this manner, the imprint apparatus 1A adjusts the back side of the template 10A to atmospheric pressure when curing the resist 30.

After the resist 30 has been cured, the template 10A is separated from the cured resist 30 (a resist pattern). Accordingly, the resist pattern, which is the reversed template pattern, is formed on the wafer Wa.

The control apparatus 21 subsequently checks whether or not imprinting on all designated areas (desired areas) on the wafer Wa is complete (Step S90). In other words, it is checked whether or not the processes of Steps S30 to S80 have been executed for all the imprint shots on the wafer Wa.

If imprinting on the designated areas on the wafer Wa is not complete (Step S90, No), the imprint apparatus 1A repeats the processes of Steps S30 to S80. The imprint apparatus 1A repeats the processes of Steps S30 to S90 until imprinting on all the designated areas on the wafer Wa is complete.

If imprinting on all the designated areas on the wafer Wa is complete (Step S90, Yes), the wafer Wa is moved (Step S100). The wafer Wa is then carried out of the imprint apparatus 1A.

When a semiconductor device (semiconductor integrated circuit) is manufactured, the imprint process of the embodiment is performed for, for example, each layer of the wafer process. Specifically, a resist pattern is formed by the imprint process on the wafer Wa. A lower layer side of the resist pattern is then etched using the resist pattern as a mask. Consequently, an actual pattern corresponding to the resist pattern is formed on the wafer Wa. When a semiconductor device is manufactured, the above-mentioned imprint process, etching process, and the like are repeated on a layer by layer basis.

The imprint process of the embodiment may be used, not limited to when a semiconductor device is manufactured, but also to when an electronic device such as a MEMS (Micro Electro Mechanical System: microelectromechanical system), a magnetic recording apparatus, a magnetic recording medium, and the like are manufactured.

When the imprint method of the embodiment is executed, the imprint apparatus 1A may not include the rear pressure adjustment mechanism 14, the flatness measurement apparatus 15, and the CCD camera 50. Moreover, after the adjustment process of adjusting the space 19 to atmospheric pressure is started and before the adjustment process is complete (before the pressure reaches atmospheric pressure), the process of applying UV light to the resist 30 may be started. Moreover, the adjustment process of adjusting the space 19 to atmospheric pressure and the process of applying UV light to the resist 30 may be started simultaneously.

In this manner, according to the first embodiment, the resist 30 is filled in the template pattern while the rear pressure of the template 10A is changed to negative pressure. Accordingly, the distorted template 10A resulting from that the template 10A is impressed onto the resist 30 can be recovered in a short time. Moreover, the squeezed-out resist 30 can be solved in a short time. Therefore, the imprint process can be executed in a short time.

### Second Embodiment

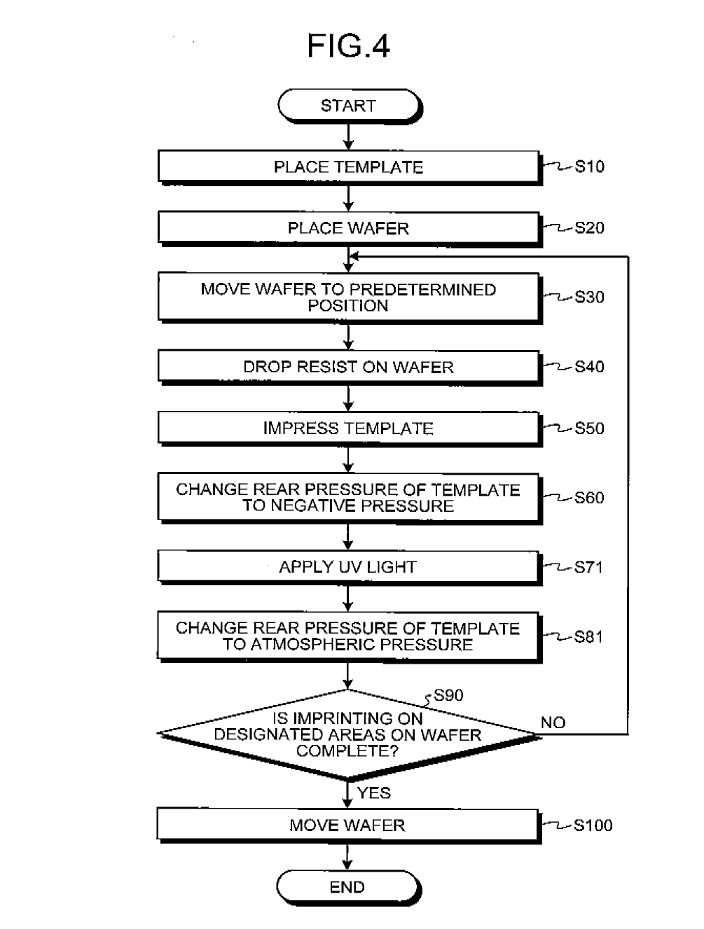

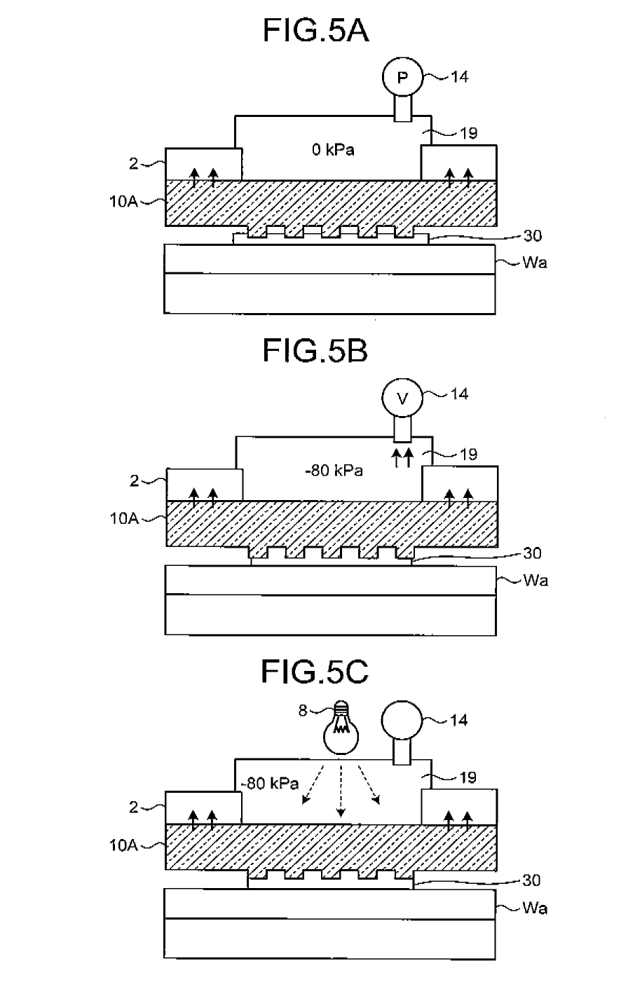

Next, a second embodiment is described with reference to FIGS. 4 and 5A to 5C. In the second embodiment, a Rigid template that is not provided on the back of the template pattern with a level difference is used as in the first embodiment. Moreover, in the second embodiment, the rear pressure of the template 10A is adjusted from negative pressure to atmospheric pressure after UV light is applied to the resist 30.

FIG. 4 is a diagram illustrating a processing procedure of an imprint step according to the second embodiment. FIGS. 5A to 5C are diagrams illustrating pressure control in the imprint step according to the second embodiment. FIGS. 5A to 5C illustrate cross-sectional views of the wafer Wa, the template 10A, and the like in the imprint step.

Among the processes of FIG. 4, the descriptions of similar processes to those of the imprint step according to the first embodiment, which is illustrated in FIG. 2, are omitted. FIG. 5A illustrates the template 10A (rear pressure: 0 kPa) of when the template 10A is pressed against the resist 30. Moreover, FIG. 5B illustrates the template 10A (rear pressure: negative pressure, for example, −80 kPa) of when the resist 30 is filled in the template pattern. Moreover, FIG. 5C illustrates the template 10A (rear pressure: negative pressure, for example, −80 kPa) of when the resist 30 is cured.

In the imprint step illustrated in FIG. 4, the processes of Steps S10 to S60, S90, and S100 are similar processes to those of the imprint step according to the first embodiment, which is illustrated in FIG. 2. The processes of Steps S70 and S80 are performed in the first embodiment while the processes of Steps S71 and S81 are performed in the second embodiment.

In other words, in the imprint step according to the second embodiment, after the back side of the template 10A is adjusted to negative pressure (Step S60), and the filling of the resist 30 is complete, the UV light source 8 applies UV light to the resist 30 through the template 10A (Step S71). At this point in time, the rear pressure of the template 10A remains at a negative pressure, for example, −80 kPa, as illustrated in FIG. 5C.

After the resist 30 has been cured, the control apparatus 21 transmits, to the rear pressure adjustment mechanism 14, an instruction to adjust the rear pressure of the template 10A to atmospheric pressure. Consequently, the rear pressure adjustment mechanism 14 compresses the space 19. As a result, the space 19 is adjusted to atmospheric pressure (0 kPa) (Step S81).

The template 10A is subsequently separated from the cured resist 30. The control apparatus 21 then checks whether or not imprinting on all designated areas (desired areas) on the wafer Wa is complete (Step S90).

If imprinting on the designated areas on the wafer Wa is not complete (Step S90, No), the imprint apparatus 1A repeats the processes of Steps S30 to S81. The imprint apparatus 1A repeats the processes of Steps S30 to S90 until imprinting on all the designated areas on the wafer Wa is complete.

If imprinting on all the designated areas on the wafer Wa is complete (Step S90, Yes), the wafer Wa is moved (Step S100). The wafer Wa is then carried out of the imprint apparatus 1A.

After the application process of applying UV light to the resist 30 is started and before the application process is complete (before all of the resist 30 is cured), the adjustment process of adjusting the space 19 to atmospheric pressure may be started.

In this manner, according to the second embodiment, the distortion of the template 10A and the squeezed-out resist 30, which result from that the template 10A is impressed onto the resist 30, can be solved in a short time as in the first embodiment. Therefore, the imprint process can be executed in a short time.

### Third Embodiment

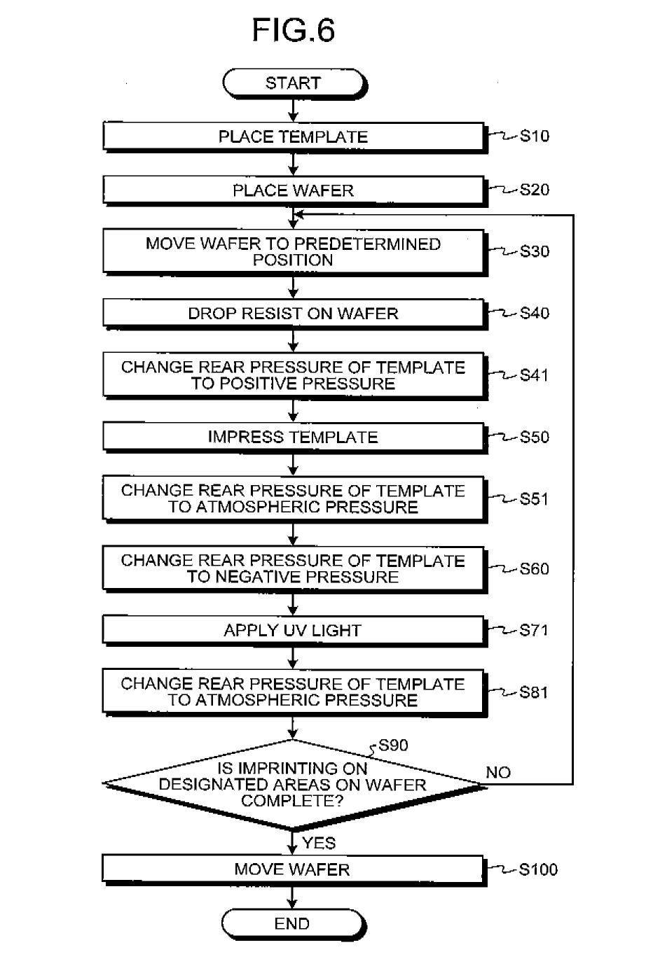

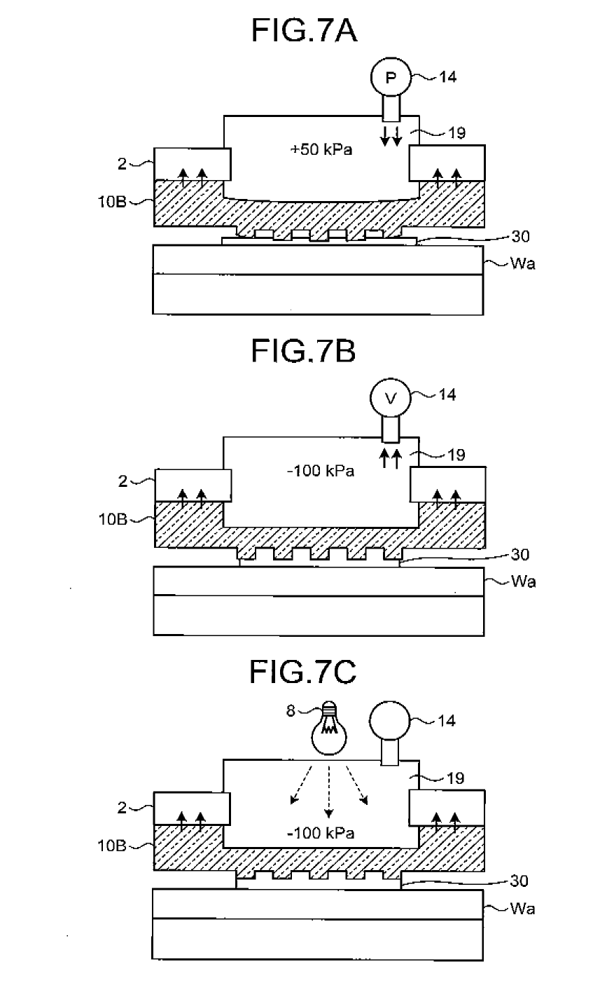

Next, a third embodiment is described with reference to FIGS. 6 and 7A to 7C. A cored-out template (Fast template) is used in the third embodiment. Moreover, in the third embodiment, after UV light is applied to the resist 30, the rear pressure of the template is adjusted from negative pressure to atmospheric pressure.

FIG. 6 is a diagram illustrating a processing procedure of an imprint step according to the third embodiment. Moreover, FIGS. 7A to 7C are diagrams illustrating pressure control in the imprint step according to the third embodiment. FIGS. 7A to 7C illustrate cross-sectional views of the wafer Wa, the template 10B described below, and the like in the imprint step.

Among the processes of FIG. 6, the descriptions of similar processes to those of the imprint step according to the first or second embodiment are omitted. FIG. 7A illustrates the template 10B (rear pressure: positive pressure, for example, +50 kPa) of when the template 10B is pressed against the resist 30. Moreover, FIG. 7B illustrates the template 10B (rear pressure: negative pressure, for example, −100 kPa) of when the resist 30 is filled in the template pattern. Moreover, FIG. 7C illustrates the template 10B (rear pressure: negative pressure, for example, −100 kPa) of when the resist 30 is cured.

The template 10B used in the embodiment is formed thinner on the back side of an area (center area) where the template pattern has been formed than on the back side of an area (outer peripheral portion area) where the template pattern has not been formed. When the template 10B is formed, the back side of the area where the template pattern has been formed is shaved off by a predetermined thickness. Consequently, the template 10B is thinner in the center area than in the outer peripheral portion area. In this manner, the template 10B is provided with a core out area (countersink) on the back side of the area where the template pattern has been formed.

In the imprint step illustrated in FIG. 6, the processes of Steps S10 to S40, and S71 to S100 are similar processes to those of the imprint step according to the second embodiment, which is illustrated in FIG. 4. The processes of Steps S50 and S60 are performed in the second embodiment while the processes of Steps S41, S50, S51, and S60 are performed in the third embodiment.

In other words, in the imprint step according to the third embodiment, after the liquid drop apparatus 11 drops the resist 30 on the wafer Wa (Step S40), the control apparatus 21 transmits, to the rear pressure adjustment mechanism 14, an instruction to adjust the rear pressure of the template 10B to positive pressure (for example, 0 to 200 kPa). Consequently, the rear pressure adjustment mechanism 14 compresses the space 19. As a result, the space 19 is adjusted to a positive pressure, for example, +50 kPa, as illustrated in FIG. 7A (Step S41).

The stage base 9 impresses the template 10B supported by the template stage 2 onto the resist 30 (Step S50). Consequently, the filling of the resist 30 in the template pattern is started. At this point in time, the control apparatus 21 transmits, to the rear pressure adjustment mechanism 14, an instruction to adjust the rear pressure of the template 10B (the space 19) to atmospheric pressure. Consequently, the rear pressure adjustment mechanism 14 adjusts the rear pressure of the template 10B to atmospheric pressure (0 kPa) (Step S51).

Furthermore, the control apparatus 21 transmits, to the rear pressure adjustment mechanism 14, an instruction to adjust the rear pressure of the template 10B to negative pressure. Consequently, the rear pressure adjustment mechanism 14 adjusts the space 19 to a negative pressure, for example, −100 kPa as illustrated in FIG. 7B (Step S60). In this manner, the imprint apparatus 1A adjusts the back side of the template 10B to negative pressure when filling the resist 30 in the template pattern. The imprint apparatus 1A subsequently executes the processes of S71 to S100 in a similar procedure to that of the second embodiment. The process of Step S41 may be executed at any timing as long as the timing is between after the process of Step S10 and before the process of Step S50.

In this manner, according to the third embodiment, the distortion of the template 10B and the squeezed-out resist 30, which result from that the template 10B is impressed onto the resist 30, can be solved in a short time as in the second embodiment. Therefore, the imprint process can be executed in a short time.

Moreover, the rear pressure of the template 10B is adjusted to positive pressure when the template 10B is pressed against the resist 30. Accordingly, it is possible to prevent bubbles from entering the resist 30.

### Fourth Embodiment

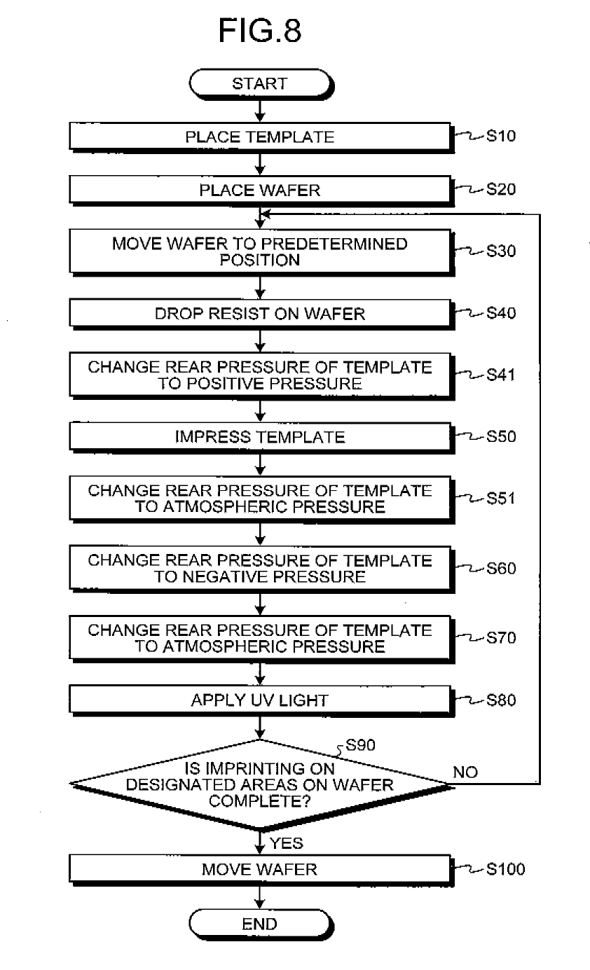

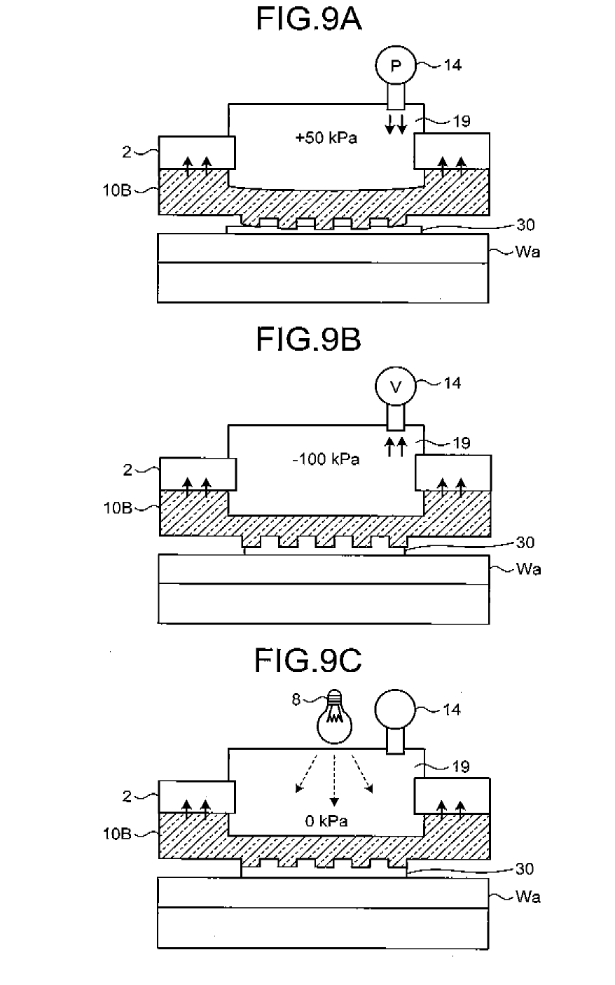

Next, a fourth embodiment is described with reference to FIGS. 8 and 9A to 9C. In the fourth embodiment, a cored-out template is used as in the third embodiment. Moreover, in the fourth embodiment, after the rear pressure of the template is adjusted from negative pressure to atmospheric pressure, UV light is applied to the resist 30 as in the first embodiment.

FIG. 8 is a diagram illustrating a processing procedure of an imprint step according to the fourth embodiment. Moreover, FIGS. 9A to 9C are diagrams illustrating pressure control in the imprint step according to the fourth embodiment. FIGS. 9A to 9C illustrate cross-sectional views of the wafer Wa, the template 10B, and the like in the imprint step.

Among the processes of FIG. 8, the descriptions of similar processes to those of the imprint steps according to the first to third embodiments are omitted. FIG. 9A illustrates the template 10B (rear pressure: positive pressure, for example, +50 kPa) of when the template 10B is pressed against the resist 30. Moreover, FIG. 9B illustrates the template 10B (rear pressure: negative pressure, for example, −100 kPa) of when the resist 30 is filled in the template pattern. Moreover, FIG. 9C illustrates the template 10B (rear pressure: atmospheric pressure) of when the resist 30 is cured.

In the imprint step illustrated in FIG. 8, the processes of Steps S10 to S60, S90, and S100 are similar processes to those of the imprint step according to the third embodiment, which is illustrated in FIG. 6. The processes of Steps S71 and S81 are performed in the third embodiment while the processes of Steps S70 and S80 similar to those of the first embodiment are performed in the fourth embodiment.

In other words, in the imprint step according to the fourth embodiment, after the back side of the template 10B is adjusted to negative pressure (Step S60) and the filling of the resist 30 is complete, the control apparatus 21 transmits, to the rear pressure adjustment mechanism 14, an instruction to adjust the rear pressure of the template 10B to atmospheric pressure. Consequently, the rear pressure adjustment mechanism 14 compresses the space 19. As a result, the space 19 is adjusted to atmospheric pressure (0 kPa) as illustrated in FIG. 9C (Step S70).

The UV light source 8 then applies UV light to the resist 30 through the template 10B (Step S80). Consequently, the resist 30 is cured. In this manner, the imprint apparatus 1A adjusts the back side of the template 10B to atmospheric pressure when curing the resist 30.

The template 10B is subsequently separated from the cured resist 30. The control apparatus 21 then checks whether or not imprinting on all designated areas on the wafer Wa is complete (Step S90).

If imprinting on the designated areas on the wafer Wa is not complete (Step S90, No), the imprint apparatus 1A repeats the processes of Steps S30 to S80. The imprint apparatus 1A repeats the processes of Steps S30 to S90 until imprinting on all the designated areas on the wafer Wa is complete.

If imprinting on all the designated areas on the wafer Wa is complete (Step S90, Yes), the wafer Wa is moved (Step S100). The wafer Wa is then carried out of the imprint apparatus 1A.

In this manner, according to the fourth embodiment, the distortion of the template 10B and the squeezed-out resist 30, which result from that the template 10B is impressed onto the resist 30, can be solved in a short time as in the third embodiment. Therefore, the imprint process can be executed in a short time.

### Fifth Embodiment

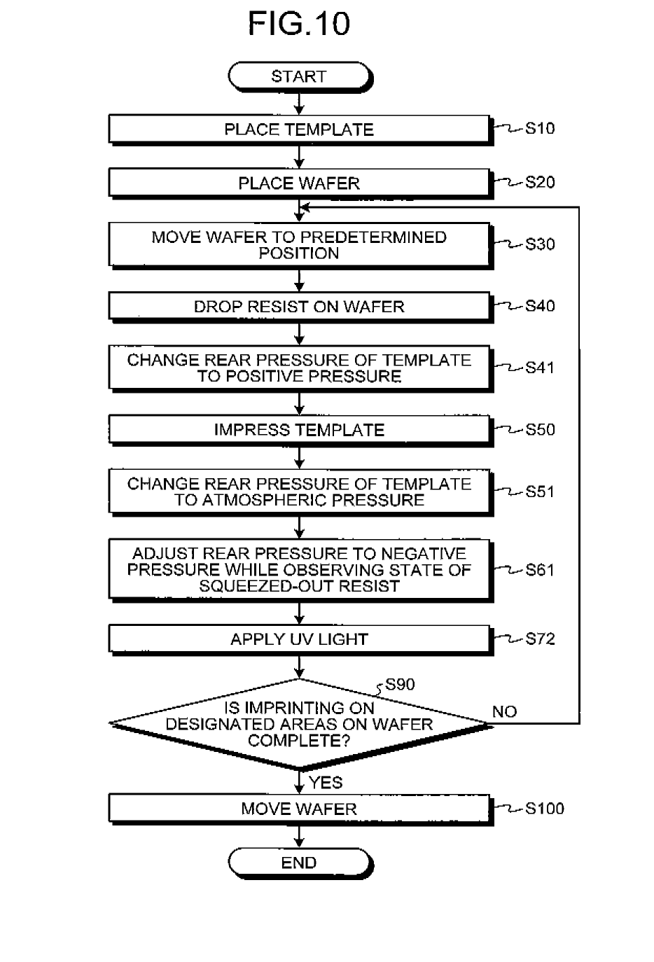

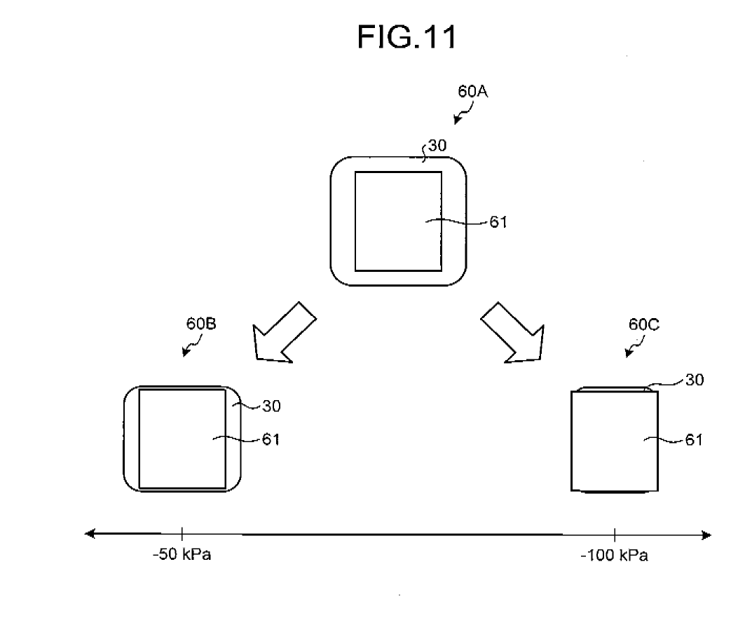

Next, a fifth embodiment is described with reference to FIGS. 10 and 11. In the fifth embodiment, the CCD camera 50 observes the state of the resist 30 squeezed out from the template pattern surface. The rear pressure of the template 103 is controlled based on the state of the squeezed-out resist 30.

FIG. 10 is a diagram illustrating a processing procedure of an imprint step according to the fifth embodiment. Among the processes of FIG. 10, the descriptions of similar processes to those of the imprint steps according to the first to fourth embodiments are omitted.

In the imprint step illustrated in FIG. 10, the processes of Steps S10 to S51, S90, and S100 are similar processes to those of the imprint step according to the third embodiment, which is illustrated in FIG. 6. The processes of Steps S60, S71, and S81 are performed in the third embodiment while the processes of Steps S61 and S72 are performed in the fifth embodiment.

In other words, in the imprint step according to the fifth embodiment, the template 10B is impressed onto the resist 30 (Step S50). After the rear pressure of the template 10B is adjusted to atmospheric pressure (Step S51), the CCD camera 50 starts observing the state of the resist 30.

The CCD camera 50 captures images of the resist 30 from above the template 10B while the resist 30 is being filled in the template pattern. Consequently, images of the back side of the template pattern and the resist 30 squeezed out from the template pattern are captured. The CCD camera 50 transmits the captured images to the control apparatus 21.

The control apparatus 21 detects the state (amount and the like) of the squeezed-out resist 30 based on the captured image. Furthermore, the control apparatus 21 controls the rear pressure of the template 10B based on the detected squeezed-out state. At this point in time, the control apparatus 21 transmits, to the rear pressure adjustment mechanism 14, an instruction to set the pressure of the space 19 to a negative pressure in accordance with the detected squeezed-out state.

For example, if the amount of distortion of the template 10B is larger than a predetermined value, the control apparatus 21 transmits, to the rear pressure adjustment mechanism 14, an instruction to make an adjustment to a first pressure (for example, −50 kPa). Consequently, the rear pressure adjustment mechanism 14 controls the pressure in accordance with the instruction of the control apparatus 21. In this manner, the imprint apparatus 1A adjusts the rear pressure of the template 10B to negative pressure while observing the state of the squeezed-out resist 30 (Step S61).

FIG. 11 is a diagram illustrating the state of the squeezed-out resist, the state being observed in the imprint step according to the fifth embodiment. FIG. 11 illustrates top views of the template 10B when viewing the template pattern from the back side. FIG. 11 illustrates the back side of a template pattern area 61 and the resist 30 squeezed out from the template pattern area 61.

A state 60A of FIG. 11 illustrates the state of the squeezed-out resist 30 of when the template 10B is pressed against the resist 30 (rear pressure: +50 kPa). Moreover, a state 60B and a state 60C of FIG. 11 illustrate the state of the squeezed-out resist 30 at the point when a predetermined time has passed since the resist 30 started being filled in the template pattern. The state 60B is the state of the squeezed-out resist 30 of when the rear pressure of the template 10B is set to −50 kPa. Moreover, the state 60C is the state of the squeezed-out resist 30 of when the rear pressure of the template 10B is set to −100 kPa.

If the rear pressure of the template 10B is −100 kPa, the amount of the squeezed-out resist 30 is reduced as compared to the case where the rear pressure of the template 10B is −50 kPa. This is because the distortion of the template 10B is solved by the amount in accordance with the rear pressure of the template 10B after a lapse of the predetermined time.

In other words, the speed to solve the squeezed-out resist 30 is a speed in accordance with the rear pressure of the template 10B. Hence, the control apparatus 21 determines the rear pressure of the template 10B based on the detected state of the squeezed-out resist 30.

For example, the control apparatus 21 instructs the rear pressure adjustment mechanism 14 to set a rear pressure with a large value (a first value) since the amount of the squeezed-out resist 30 is large in the beginning. When the amount of the squeezed-out resist 30 is subsequently reduced, the control apparatus 21 instructs the rear pressure adjustment mechanism 14 to set a rear pressure with a smaller value (a second value smaller than the first value).

Consequently, in the early stage of the filling of the resist 30, resist squeeze-out is solved at high speeds. Moreover, in the last stage of the filling of the resist 30, resist squeeze-out is solved with high precision.

When the filling of the resist 30 is complete, the UV light source 8 applies UV light to the resist 30 through the template 10B (Step S72). The template 10B is subsequently separated from the cured resist 30. The control apparatus 21 then checks whether or not imprinting on all designated areas on the wafer Wa is complete (Step S90).

If imprinting on the designated areas on the wafer Wa is not complete (Step S90, No), the imprint apparatus 1A repeats the processes of Steps S30 to S72. The imprint apparatus 1A repeats the processes of Steps S30 to S90 until imprinting on all the designated areas on the wafer Wa is complete.

If imprinting on all the designated areas on the wafer Wa is complete (Step S90, Yes), the wafer Wa is moved (Step S100). The wafer Wa is then carried out of the imprint apparatus 1A.

The timing when the rear pressure of the template 10B is returned to atmospheric pressure after the filling of the resist 30 may be any timing. In other words, after the resist 30 is filled, the imprint apparatus 1A can first execute either of the UV light application process and the process of adjusting the rear pressure of the template 10B to atmospheric pressure. In other words, the rear pressure of the template 10B upon the application of UV light may be negative pressure or atmospheric pressure. Moreover, the imprint apparatus 1A may fill the resist 30 in the template pattern while exhausting the inside of the space 19 at an exhaust velocity in accordance with the state of the squeezed-out resist 30.

In this manner, according to the fifth embodiment, the imprint apparatus 1A adjusts the rear pressure of the template 10B to negative pressure while observing the state of the squeezed-out resist 30. Accordingly, the distortion of the template 10B and the squeezed-out resist 30 can be solved in a short time. Therefore, the imprint process can be executed in a short time.

### Sixth Embodiment

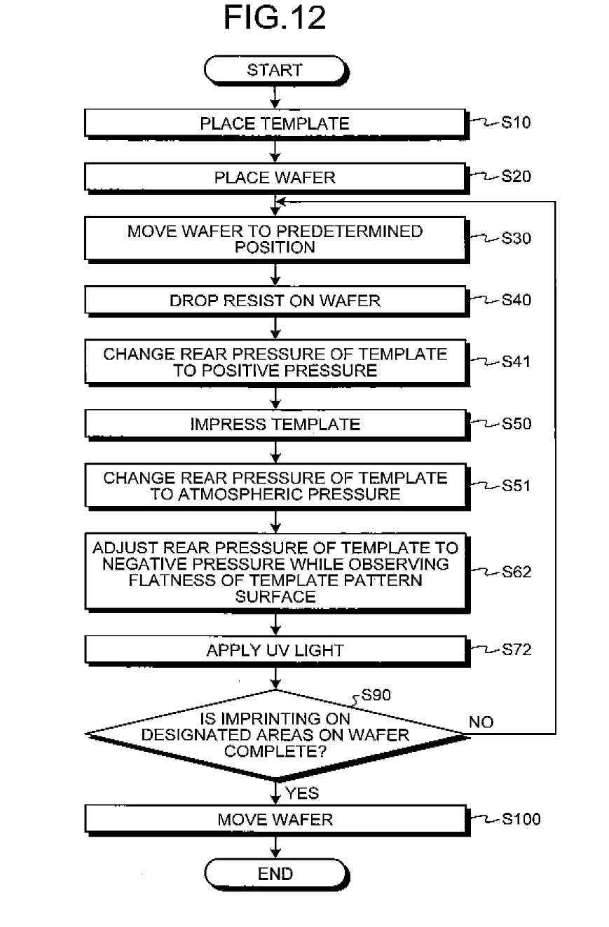

Next, a sixth embodiment is described with reference to FIG. 12. In the sixth embodiment, the flatness measurement apparatus 15 measures the flatness of the template 10B. The rear pressure of the template 10B is controlled based on the flatness of the template 10B.

FIG. 12 is a diagram illustrating a processing procedure of an imprint step according to the sixth embodiment. Among the processes of FIG. 12, the descriptions of similar processes to those of the imprint steps according to the first to fifth embodiments are omitted.

In the imprint step illustrated in FIG. 12, the processes of Steps S10 to S51, S72, S90, and S100 are similar processes to those of the imprint step according to the fifth embodiment, which is illustrated in FIG. 10. The process of Step S61 is performed in the fifth embodiment while the process of Step S62 is performed in the sixth embodiment.

In other words, in the imprint step according to the sixth embodiment, the template 10B is impressed onto the resist 30 (Step S50). After the rear pressure of the template 10B is adjusted to atmospheric pressure (Step S51), the flatness measurement apparatus 15 measures the flatness of the template 10B.

The flatness measurement apparatus 15 measures the flatness of the template 10B from the back side of the template 10B while the resist 30 is being filled in the template pattern. The flatness measurement apparatus 15 transmits the measured flatnesses to the control apparatus 21. The control apparatus 21 controls the rear pressure of the template 10B based on the measured flatnesses. The control apparatus 21 transmits, to the rear pressure adjustment mechanism 14, an instruction to set the pressure of the space 19 to a negative pressure in accordance with the flatness. The control apparatus 21 transmits, to the rear pressure adjustment mechanism 14, an instruction to set a negative pressure at which the pattern surface of the template 10B becomes flat.

For example, if the amount of distortion of the template 10B is larger than a predetermined value, the control apparatus 21 transmits, to the rear pressure adjustment mechanism 14, an instruction to make an adjustment to a first pressure (for example, −50 kPa). Consequently, the rear pressure adjustment mechanism 14 controls the pressure in accordance with the instruction of the control apparatus 21. In this manner, the imprint apparatus 1A adjusts the rear pressure of the template 10B to negative pressure while observing the flatness of the template pattern surface (Step S62).

In a similar processing procedure to that of the fifth embodiment, the processes of Steps S72, S90, and S100 are subsequently executed. In other words, if imprinting on designated areas on the wafer Wa is not complete (Step S90, No), the imprint apparatus 1A repeats the processes of Steps S30 to S72. The imprint apparatus 1A repeats the processes of Steps S30 to S90 until imprinting on all the designated areas on the wafer Wa is complete.

If imprinting on all the designated areas on the wafer Wa is complete (Step S90, Yes), the wafer Wa is moved (Step S100). The wafer Wa is then carried out of the imprint apparatus 1A.

The imprint apparatus 1A may fill the resist 30 in the template pattern while setting the inside of the space 19 to a negative pressure in accordance with the state of the squeezed-out resist 30 and the flatness of the template 10B.

In this manner, according to the sixth embodiment, the imprint apparatus 1A adjusts the rear pressure of the template 10B to negative pressure while observing the flatness of the template 10B. Accordingly, the distortion of the template 10B and the squeezed-out resist 30 can be solved in a short time. Therefore, the imprint process can be executed in a short time.

Moreover, when the resist 30 is filled in the template pattern, the rear pressure of the template 10B is adjusted to negative pressure to make the pattern surface of the template 10B flat. Accordingly, the distortion of the template pattern can be solved in a short time.

### Seventh Embodiment

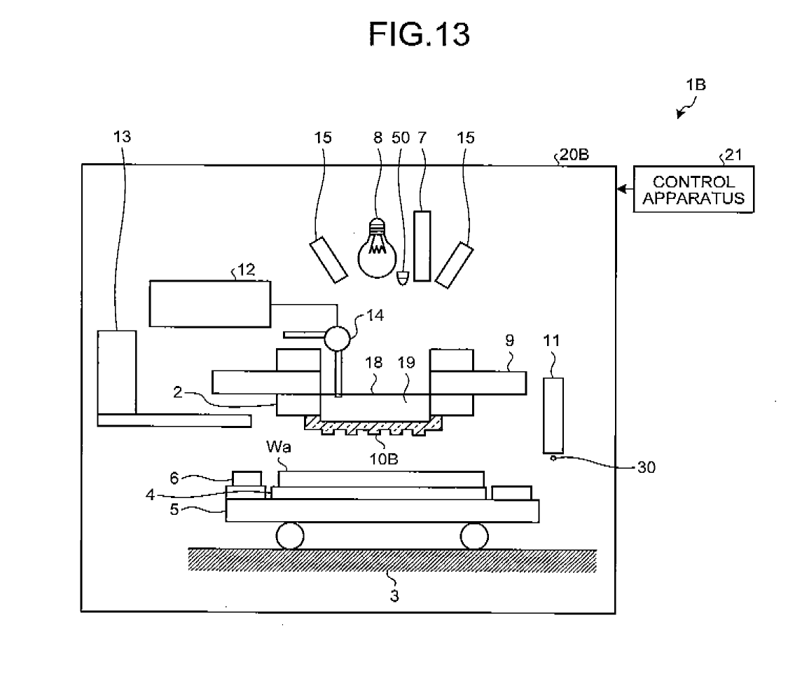

Next, a seventh embodiment is described with reference to FIGS. 13 to 15D. In the seventh embodiment, the exhaust velocity of when the rear pressure of the template 10B is adjusted is controlled based on the flatness of the template 10B.

FIG. 13 is a diagram illustrating the configuration of an imprint apparatus according to the seventh embodiment. An imprint apparatus 1B includes a processing mechanism 20B and the control apparatus 21. The processing mechanism 20B of the embodiment includes an exhaust velocity adjustment mechanism 12 in addition to the components of the processing mechanism 20A.

The exhaust velocity adjustment mechanism 12 is connected to the rear pressure adjustment mechanism 14. The exhaust velocity adjustment mechanism 12 adjusts the exhaust velocity of when the rear pressure adjustment mechanism 14 adjusts the rear pressure, in accordance with an instruction of the control apparatus 21.

In the embodiment, the flatness measurement apparatus 15 measures the flatness of the template 10B. The exhaust velocity adjustment mechanism 12 then adjusts the exhaust velocity of when the rear pressure of the template 10B to an exhaust velocity in accordance with the flatness of the template 10B.

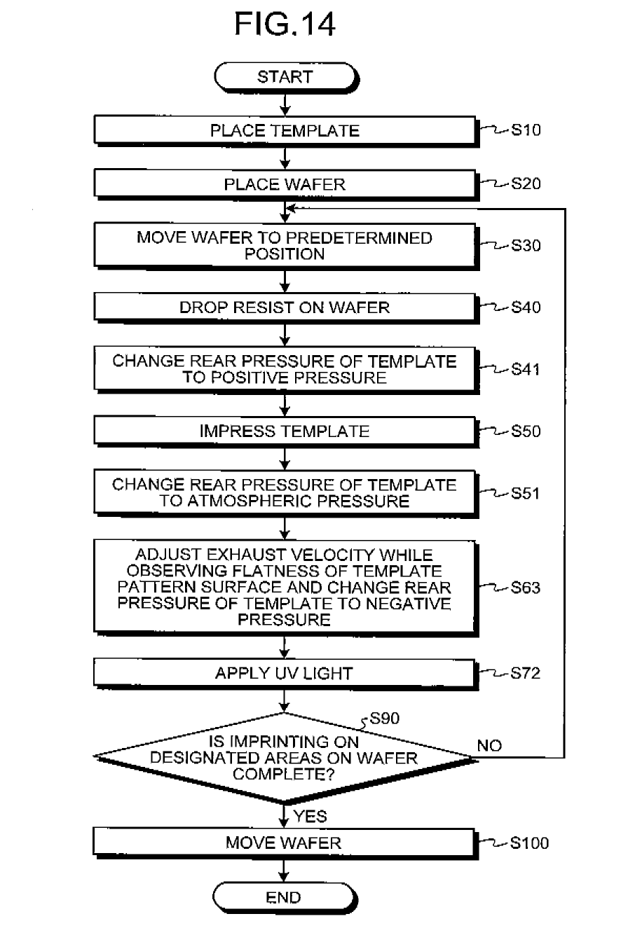

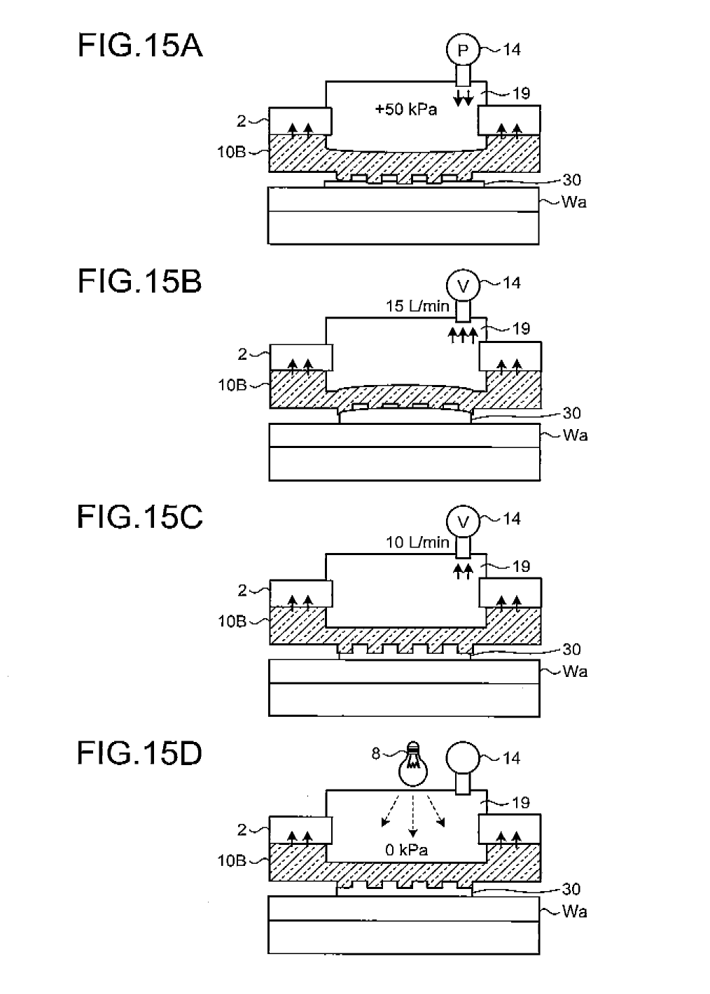

FIG. 14 is a diagram illustrating a processing procedure of an imprint step according to the seventh embodiment. Moreover, FIGS. 15A to 15D are diagrams illustrating pressure control and exhaust velocities in the imprint step according to the seventh embodiment. FIGS. 15A to 15D illustrate cross-sectional views of the wafer Wa, the template 10B, and the like in the imprint step.

Among the processes of FIG. 14, the descriptions of similar processes to those of the imprint steps according to the first to sixth embodiments are omitted. FIG. 15A illustrates the template 10B (rear pressure: +50 kPa) of when the template 10B is pressed against the resist 30. Moreover, FIGS. 15B and 15C illustrate the template 10B (the exhaust velocity) of when the resist 30 is filled in the template pattern. Moreover, FIG. 15D illustrates the template 10B (rear pressure: atmospheric pressure) of when the resist 30 is cured.

In the imprint step illustrated in FIG. 14, the processes of Steps S10 to S51, S72, S90, and S100 are similar processes to those of the imprint step according to the sixth embodiment, which is illustrated in FIG. 12. The process of Step S62 is performed in the sixth embodiment while the process of Step S63 is performed in the seventh embodiment.

In other words, in the imprint step according to the seventh embodiment, the template 10B is impressed onto the resist 30 (Step S50). After the rear pressure of the template 10B is adjusted to atmospheric pressure (Step S51), the flatness measurement apparatus 15 measures the flatness of the template 10B, and transmits the measured flatness (measurement result) to the control apparatus 21.

The control apparatus 21 controls the exhaust velocity of when the rear pressure of the template 10B is adjusted, based on the measured flatness. The control apparatus 21 transmits, to the exhaust velocity adjustment mechanism 12, an instruction to set an exhaust velocity in accordance with the flatness.

For example, if the amount of distortion of the template 10B is larger than a predetermined value, the control apparatus 21 transmits, to the rear pressure adjustment mechanism 14, an instruction to exhaust at a first exhaust velocity. Consequently, the exhaust velocity adjustment mechanism 12 adjusts the exhaust velocity in accordance with the instruction of the control apparatus 21. In this manner, the imprint apparatus 1B adjusts the exhaust velocity while observing the flatness of the template pattern surface, and adjusts the rear pressure of the template 10B to negative pressure (Step S63).

For example, in the early stage of the filling of the resist 30, the control apparatus 21 transmits, to the exhaust velocity adjustment mechanism 12, an instruction to exhaust the rear pressure of the template 10B at 15 L/min, as illustrated in FIG. 15B. Consequently, the exhaust velocity adjustment mechanism 12 causes the rear pressure adjustment mechanism 14 to exhaust at 15 L/min. As a result, the space 19 is adjusted to, for example, −60 kPa.

Moreover, in the last stage of the filling of the resist 30, the control apparatus 21 transmits, to the exhaust velocity adjustment mechanism 12, an instruction to exhaust the rear pressure of the template 10B at 10 L/min as illustrated in FIG. 15C. Consequently, the exhaust velocity adjustment mechanism 12 causes the rear pressure adjustment mechanism 14 to exhaust at 10 L/min. As a result, the space 19 is adjusted to, for example, −100 kPa.

Consequently, in the early stage of the filling of the resist 30, resist squeeze-out is solved at high speeds. Moreover, in the last stage of the filling of the resist 30, resist squeeze-out is solved with high precision.

After the filling of the resist 30 is complete, the processes of Steps S72, S90, and S100 are executed in a similar processing procedure to that of the sixth embodiment. In other words, if imprinting on designated areas on the wafer Wa is not complete (Step S90, No), the imprint apparatus 1B repeats the processes of Steps S30 to S72. The imprint apparatus 1B repeats the processes of Steps S30 to S90 until imprinting on all the designated areas on the wafer Wa is complete.

If imprinting on all the designated areas on the wafer Wa is complete (Step S90, Yes), the wafer Wa is moved (Step S100). The wafer Wa is then carried out of the imprint apparatus 1B.

The imprint apparatus 1B may fill the resist 30 in the template pattern while exhausting the inside of the space 19 at an exhaust velocity in accordance with the state of the squeezed-out resist 30 and the flatness of the template 10B.

Moreover, the imprint apparatus 1B may fill the resist 30 in the template pattern while setting an exhaust velocity in the space 19 in accordance with the state of the squeezed-out resist 30 and the flatness of the template 10B.

In this manner, according to the seventh embodiment, the imprint apparatus 1B adjusts the exhaust velocity while observing the flatness of the template 10B. Accordingly, the distortion of the template 10B and the squeezed-out resist 30 can be solved in a short time. Therefore, the imprint process can be executed in a short time.

### Eighth Embodiment

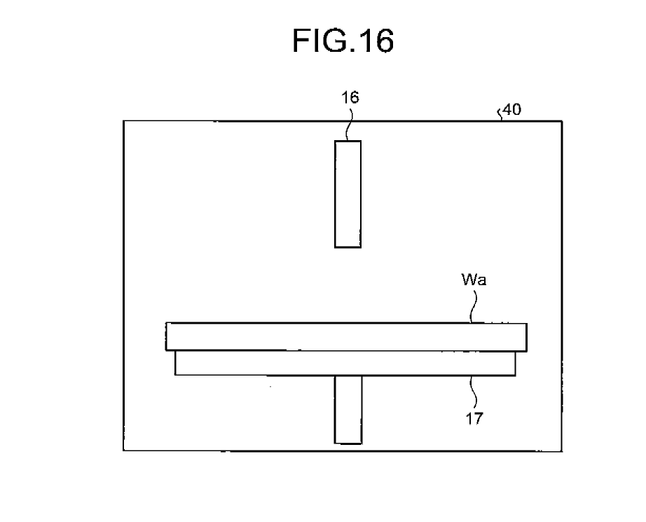

Next, an eighth embodiment is described with reference to FIGS. 16 to 18C. In the eighth embodiment, a template pattern is transferred to the wafer Wa on which the resist 30 has been applied by spin coating.

An imprint apparatus 1C (not illustrated) of the embodiment is an apparatus that repeats the process of impressing the template 10B onto the resist 30 and the process of separating the template 10B from the resist 30 on an imprint shot by imprint shot basis, after the resist 30 is applied substantially all over the surface of the wafer Wa.

The imprint apparatus 1C includes a spin coating mechanism 40 instead of the liquid drop apparatus 11 of the imprint apparatus 1B. FIG. 16 is a diagram illustrating the configuration of the spin coating mechanism according to the eighth embodiment. The spin coating mechanism 40 includes a discharge nozzle 16 and a rotating table 17.

The rotating table 17 supports the wafer Wa from the back side and rotates the wafer Wa in a plane parallel to the main surface of the wafer Wa. The discharge nozzle 16 is a nozzle that discharges the resist 30. The discharge nozzle 16 is placed above the rotating table 17, and discharges the resist 30 onto the wafer Wa on the rotating table 17.

When imprinting on the wafer Wa, the wafer Wa is fixed on the rotating table 17. The rotating table 17 then rotates the wafer Wa. The discharge nozzle 16 subsequently discharges the resist 30 onto the wafer Wa. Consequently, the resist 30 is applied substantially all over the surface of the wafer Wa.

After the resist 30 has been applied over the wafer Wa, the wafer Wa is fixed on the sample stage 5. The wafer Wa on the sample stage 5 is subsequently moved to directly below the template 10B. The template 10B is then pressed against the resist 30 on the wafer Wa.

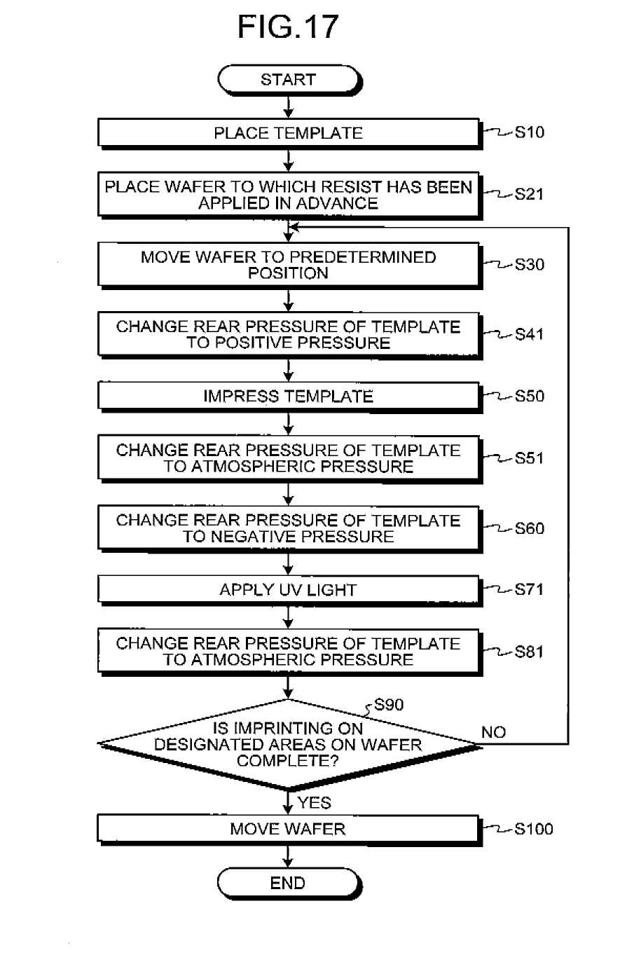

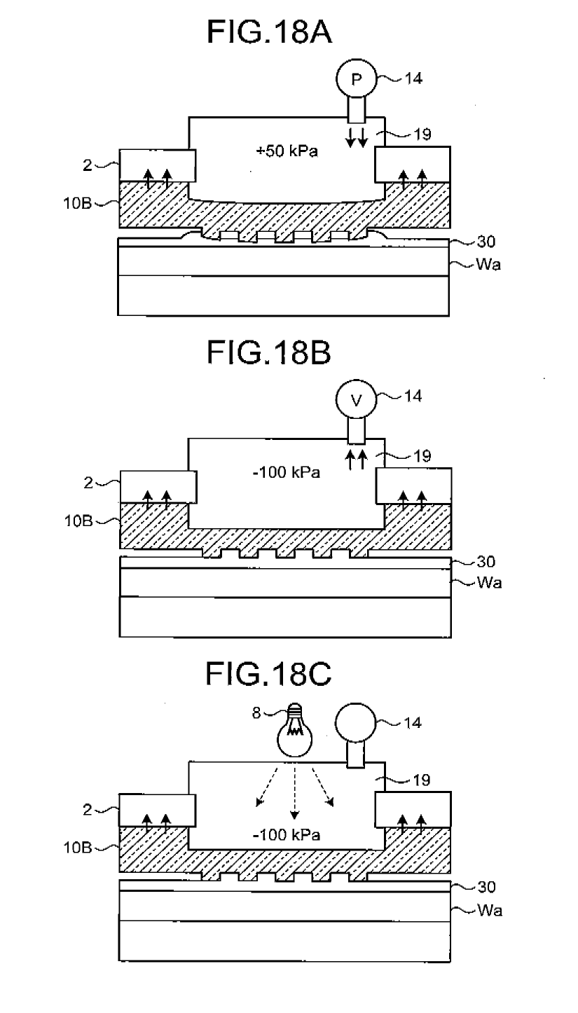

FIG. 17 is a diagram illustrating a processing procedure of an imprint step according to the eighth embodiment. Moreover, FIGS. 18A to 18C are diagrams illustrating pressure control in the imprint step according to the eighth embodiment. FIGS. 18A to 18C illustrate cross-sectional views of the wafer Wa, the template 10B, and the like in the imprint step.

Among the processes of FIG. 17, the descriptions of similar processes to those of the imprint steps according to the first to seventh embodiments are omitted. FIG. 18A illustrates the template 10B (rear pressure: +50 kPa) of when the template 10B is pressed against the resist 30. Moreover, FIG. 18B illustrates the template 10B (rear pressure: −100 kPa) of when the resist 30 is filled in the template pattern. Moreover, FIG. 18C illustrates the template 10B (rear pressure: −100 kPa) of when the resist 30 is cured.

In the imprint step illustrated in FIG. 17, the processes of Steps S10, S30, S41 to S100 are similar processes to those of the imprint step according to the third embodiment, which is illustrated in FIG. 6. The process of Step S20 is performed in the third embodiment while the process of Step S21 is performed in the eighth embodiment. Moreover, the process of Step S40 is performed in the third embodiment while the process of Step S40 is performed in the eighth embodiment.

In other words, the imprint step according to the eighth embodiment, the template 10B is placed at a predetermined position in the processing mechanism 20B (Step S10). The wafer Wa where the resist 30 has been applied in advance substantially all over the surface is placed at a predetermined position in the processing mechanism 20B (Step S21).

The wafer Wa is subsequently moved by the sample stage 5 to a predetermined position (below the liquid drop apparatus 11) (Step S30). The control apparatus 21 then transmits, to the rear pressure adjustment mechanism 14, an instruction to adjust the rear pressure of the template 10B to positive pressure. Consequently, the rear pressure adjustment mechanism 14 compresses the space 19. As a result, the space 19 is adjusted to a positive pressure, for example, +50 kPa, as illustrated in FIG. 18A (Step S41). In a similar processing procedure to that of the third embodiment, the processes of Steps S50 to S100 are subsequently executed.

In this manner, in the eighth embodiment, the imprint apparatus 1C sets the rear pressure of the template 10B to negative pressure when filling the spin coated resist 30. Hence, the distorted template 10B resulting from that the template 10B is impressed onto the resist 30 can be recovered in a short time. Moreover, the squeezed-out resist 30 can be solved in a short time. Therefore, the imprint process can be executed in a short time.

The imprint methods described in the first to eighth embodiments may be combined. For example, the imprint methods described in the first to eighth embodiments may use the template 10A or may use the template 10B.

Moreover, the imprint methods described in the first to eighth embodiments may drop the resist 30 on the wafer Wa by the inkjet method, or may apply the resist 30 to the wafer Wa by spin coating.

Moreover, the imprint methods described in the first to eighth embodiments may adjust the rear pressure of the template 10A/10B to positive pressure or atmospheric pressure when the template 10A/10B is pressed against the resist 30 (when starting a press).

Moreover, the imprint method described in the fifth embodiment may be applied to the imprint methods described in the embodiments other than the fifth embodiment. Moreover, the imprint method described in the sixth embodiment may be applied to the imprint methods described in the embodiments other than the sixth embodiment. Moreover, the imprint method described in the seventh embodiment may be applied to the imprint methods described in the embodiments other than the seventh embodiment.

Moreover, the imprint methods described in the fifth to seventh embodiments can first execute either of the process of curing the resist 30 and the process of returning the rear pressure of the templates 10A/10B to atmospheric pressure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A pattern forming method comprising:
bringing a template pattern formed on a front side of a template into contact with resist placed on a substrate;
adjusting, to a first pressure, pressure inside an apparatus on which the template is placed;
adjusting, to a second pressure, rear pressure being ambient pressure on a back side of the template, the second pressure being lower than the first pressure;
filling the resist in the template pattern under the second pressure; and
curing the resist.

2. The pattern forming method according to claim 1, wherein
upon the filling, the state of the resist squeezed out from a template pattern surface is detected, and
the resist is filled in the template pattern while the rear pressure is adjusted to a second pressure in accordance with the squeezed-out state.

3. The pattern forming method according to claim 1, wherein
upon the filling, the state of the resist squeezed out from a template pattern surface is detected, and
the resist is filled in the template pattern while an exhaust velocity upon the adjustment of the rear pressure is adjusted to a velocity in accordance with the squeezed-out state.

4. The pattern forming method according to claim 1, wherein
upon the filling, the flatness of the template is measured, and
the resist is filled in the template pattern while the rear pressure is adjusted to a second pressure in accordance with the flatness.

5. The pattern forming method according to claim 1, wherein
upon the filling, the flatness of the template is measured, and
the resist is filled in the template pattern while an exhaust velocity upon the adjustment of the rear pressure is adjusted to a velocity in accordance with the flatness.

6. The pattern forming method according to claim 1, wherein
upon the filling, the state of the resist squeezed out from a template pattern surface and the flatness of the template are measured, and
the resist is filled in the template pattern while the rear pressure is adjusted to a second pressure in accordance with the squeezed-out state and the flatness.

7. The pattern forming method according to claim 1, wherein
upon the filling, the state of the resist squeezed out from a template pattern surface and the flatness of the template are measured, and
the resist is filled in the template pattern while an exhaust velocity upon the adjustment of the rear pressure is adjusted to a velocity in accordance with the squeezed-out state and the flatness.

8. The pattern forming method according to claim 1, wherein
upon the filling, the rear pressure is adjusted to a second pressure at which a template pattern surface becomes flat.

9. The pattern forming method according to claim 1, wherein
the process of adjusting the rear pressure to atmospheric pressure is started after the filling, and the process of curing the resist is subsequently started.

10. The pattern forming method according to claim 1, wherein
the process of adjusting the rear pressure to atmospheric pressure is started after the process of curing the resist is started.

11. The pattern forming method according to claim 1, wherein
the process of adjusting the rear pressure to atmospheric pressure and the process of curing the resist are simultaneously started after the filling.

12. The pattern forming method according to claim 1, wherein
upon the contact, the rear pressure is adjusted to positive pressure.

13. The pattern forming method according to claim 1, wherein
upon the contact, the rear pressure is adjusted to atmospheric pressure.

14. The pattern forming method according to claim 1, wherein
the process of placing the resist on the substrate, the contact, the process of adjusting the rear pressure to a second pressure, the filling, and the curing are performed for each shot set on the substrate.

15. The pattern forming method according to claim 1, wherein
the resist is placed by spin coating on the substrate, and the contact, the process of adjusting the rear pressure to a second pressure, the filling, and the curing are subsequently performed for each shot set on the substrate.

16. A pattern forming apparatus comprising:
a contact processing unit that brings a template pattern formed on a front side of a template into contact with resist placed on a substrate, and fill the resist in the template pattern;
a pressure adjustment unit that adjusts rear pressure being ambient pressure on a back side of the template;
a curing processing unit that cures the resist; and
a control unit that controls the pressure adjustment unit, wherein
the control unit transmits, to the pressure adjustment unit, an instruction to adjust the rear pressure to a second pressure upon the filling.

17. The pattern forming apparatus according to claim 16, further comprising a resist detection unit that detects the state of the resist squeezed out from a template pattern surface upon the filling, wherein
upon the filling, the control unit transmits, to the pressure adjustment unit, an instruction to adjust the rear pressure to a second pressure in accordance with the squeezed-out state.

18. The pattern forming apparatus according to claim 16, further comprising a resist detection unit that detects the state of the resist squeezed out from a template pattern surface upon the filling, wherein
upon the filling, the control unit transmits, to the pressure adjustment unit, an instruction to adjust an exhaust velocity upon the adjustment of the rear pressure to a velocity in accordance with the squeezed-out state.

19. The pattern forming apparatus according to claim 16, further comprising a flatness measurement unit that measures the flatness of the template, wherein
upon the filling, the control unit transmits, to the pressure adjustment unit, an instruction to adjust the rear pressure to a second pressure in accordance with the flatness.

20. The pattern forming apparatus according to claim 16, further comprising a flatness measurement unit that measures the flatness of the template, wherein
upon the filling, the control unit transmits, to the pressure adjustment unit, an instruction to adjust an exhaust velocity upon the adjustment of the rear pressure to a velocity in accordance with the flatness.
